(19) United States
(12) Patent Application Publication
(10) Pub. No.: US 2020/0380965 A1
(43) Pub. Date: Dec. 3, 2020

(54) METHOD FOR GENERATING SPEECH, APPARATUS, DEVICE AND STORAGE MEDIUM

(71) Applicant: BAIDU ONLINE NETWORK TECHNOLOGY (BEIJING) CO., LTD., Beijing (CN)

(72) Inventors: Hongwei Cao, Beijing (CN); Lixian Xi, Beijing (CN); Peng Yuan, Beijing (CN)

(21) Appl. No.: 16/882,622

(22) Filed: May 25, 2020

(30) Foreign Application Priority Data
May 31, 2019 (CN) 201910468039.9

(51) Int. Cl. G10L 15/18; G10L 15/22

(52) U.S. Cl. CPC G10L 15/1815; G10L 15/22

(57) ABSTRACT

The disclosure provides a method for generating speech, an apparatus, a device and a storage medium, the method includes: generating an interaction intention of each node in an intelligent dialogue system according to an interaction description file, where the interaction description file includes node information of each node in the intelligent dialogue system, obtaining, according to the interaction intention and the interaction description file, at least one speech corresponding to each node in the intelligent dialogue system by using a generalization process, and storing at least one speech corresponding to each node, high efficiency of generating speech is achieved by automatically generating the interaction intention of each node according to the description file, thereby generating at least one speech of each node, and the speech is enriched through the generalization process, avoiding the problem that the speech is insufficient in the prior art.

### CROSS-REFERENCE TO RELATED APPLICATION

This application claims priority to Chinese Patent Application No. CN201910468039.9, filed on May 31, 2019, which is hereby incorporated by reference in its entirety.

### TECHNICAL FIELD

The embodiments of the present disclosure relate to a field of voice interaction, and in particular to a method for generating speech, an apparatus, a device and a storage medium.

### BACKGROUND

With continuous development of the field of voice interaction, a variety of voice interaction devices are increasingly applied to all aspects of people's lives, providing various skills services for people's lives.

In practical applications, when a user conducts a dialogue with a voice interaction device, expressing a same intention may use a plurality of different speech, the voice interaction device needs to recognize the user's intention through multiple speech of the user, therefore, completing the interaction according to multiple speech is a development difficulty of the voice interaction device currently used to provide skills services, in the prior art, a relationship between an intention and a skill service is established by a developer manually creating the intention according to a node, writing possible speech according to the created intention, and writing a corresponding code logic.

However, there are multiple nodes in a voice interaction system, it is inefficient to create the corresponding intention for each node, and write the possible speech of each node, moreover, a process of converting intention into speech through human translation may result in insufficient speech.

### SUMMARY

The embodiments of the disclosure provide a method for generating speech, an apparatus, a device and a storage medium, which are used for solving a problem that a process of generating speech is complicated and the speech is insufficient in the prior art.

In a first aspect, an embodiment of the disclosure provides a method for generating speech, including:

generating an interaction intention of each node in an intelligent dialogue system according to an interaction description file, where the interaction description file includes node information of each node in the intelligent dialogue system;

obtaining, according to the interaction intention and the interaction description file, at least one speech corresponding to each node in the intelligent dialogue system by using a generalization process; and

storing at least one speech corresponding to each node.

In a specific implementation, before the generating an interaction intention of each node in an intelligent dialogue system according to an interaction description file, the method further includes:

receiving a tree menu of the intelligent dialogue system input by a user, the tree menu is used to represent a relationship between each node; generating the interaction description file according to the tree menu;

or,

receiving the interaction description file imported by the user.

Specifically, the generating an interaction intention of each node in an intelligent dialogue system according to an interaction description file, including:

generating the interaction intention of the node according to each node and at least one of a superior node of the node and a subordinate node of the node.

In a specific implementation, before the storing at least one speech corresponding to each node, the method further includes:

pushing at least one speech of each node to the user; and

obtaining at least one modified speech of each node input by the user.

Optionally, the method further includes:

generating an interaction code frame template of the intelligent dialogue system according to the interaction intention of each node; and

obtaining a skill service action corresponding to the interaction intention of each node input by the user in the interaction code frame template.

Further, the method further includes:

verifying whether the interaction description file is a valid interaction description file;

generating a prompt message if the interaction description file is not a valid interaction description file, where the prompt message is used to prompt the user to re-edit the tree menu or re-import the interaction description file.

In a second aspect, an embodiment of the present disclosure provides an apparatus for generating speech, including:

an intention generating module, configured to generate an interaction intention of each node in an intelligent dialogue system according to an interaction description file, where the interaction description file includes node information of each node in the intelligent dialogue system;

a speech generating module, configured to obtain, according to the interaction intention and the interaction description file, at least one speech corresponding to each node in the intelligent dialogue system by using a generalization process; and

a storing module, configured to store at least one speech corresponding to each node.

In a specific implementation, the apparatus further includes:

a visual editing module, configured to receive a tree menu of the intelligent dialogue system input by a user, where the tree menu is used to represent a relationship between each node; the visual editing module is further configured to generate the interaction description file according to the tree menu;

or,

an interaction file management module, configured to receive the interaction description file imported by the user.

Specifically, the intention generating module is specifically configured to:

generate the interaction intention of the node according to each node and a superior node of the node and/or a subordinate node of the node.

In a specific implementation, the apparatus further includes:

a pushing module, configured to push at least one speech of each node to the user; and

a speech editing module, configured to obtain at least one modified speech of each node input by the user.

Optionally, the apparatus further includes:

a code generating module, configured to generate an interaction code frame template of the intelligent dialogue system according to the interaction intention of each node; and

an obtaining module, configured to obtain a skill service action corresponding to the interaction intention of each node input by the user in the interaction code frame template.

Further, the interaction file management module is further configured to:

verify whether the interaction description file is a valid interaction description file;

generate a prompt message if the interaction description file is not a valid interaction description file, where the prompt message is used to prompt the user to re-edit a tree menu or re-import the description file.

In a third aspect, an embodiment of the present disclosure provides an electronic device, including: a processor, a memory, and a computer program;

the memory stores computer-executable instructions;

the processor executes the computer-executable instructions stored in the memory, such that the electronic device performs the method for generating speech as described in the first aspect.

In a fourth aspect, an embodiment of the present disclosure provides a computer readable storage medium, the computer readable storage medium is stored with computer-executable instructions which, when executed by a processor, implement the method for generating speech according to the first aspect.

The embodiments of the present disclosure provides a method for generating speech, an apparatus, a device and a storage medium, by generating an interaction intention of each node in an intelligent dialogue system according to an interaction description file, where the interaction description file includes node information of each node in the intelligent dialogue system, obtaining, according to the interaction intention and the interaction description file, at least one speech corresponding to each node in the intelligent dialogue system by using a generalization process, and storing at least one speech corresponding to each node, high efficiency of generating speech is achieved by automatically generating the interaction intention of each node according to the description file, thereby generating at least one speech of each node, and the speech is enriched through the generalization process, avoiding the problem that the speech is insufficient in the prior art.

### BRIEF DESCRIPTION OF THE DRAWINGS

In order to more clearly illustrate the embodiments of the present disclosure or the technical solutions in the prior art, a brief description of the drawings used in the embodiments or the prior art description will be briefly described below, obviously, the drawings in following description are some embodiments of the present disclosure, and those skilled in the art can obtain other drawings according to the drawings without any inventive labor.

FIG. 1 is a schematic flowchart of Embodiment 1 of a method for generating speech according to an embodiment of the present disclosure;

FIG. 2 is a schematic flowchart of Embodiment 2 of a method for generating speech according to an embodiment of the present disclosure;

FIG. 3 is a schematic flowchart of Embodiment 3 of a method for generating speech according to an embodiment of the present disclosure;

FIG. 4 is a schematic flowchart of Embodiment 4 of a method for generating speech according to an embodiment of the present disclosure;

FIG. 5 is a schematic flowchart of Embodiment 5 of a method for generating speech according to an embodiment of the present disclosure;

FIG. 6 is a schematic flowchart of Embodiment 6 of a method for generating speech according to an embodiment of the present disclosure;

FIG. 7 is a schematic structural diagram of Embodiment 1 of an apparatus for generating speech according to an embodiment of the present disclosure;

FIG. 8 is a schematic structural diagram of Embodiment 2 of an apparatus for generating speech according to an embodiment of the present disclosure;

FIG. 9 is a schematic structural diagram of Embodiment 3 of an apparatus for generating speech according to an embodiment of the present disclosure;

FIG. 10 is a schematic structural diagram of Embodiment 4 of an apparatus for generating speech according to an embodiment of the present disclosure; and

FIG. 11 is a schematic structural diagram of hardware of an electronic device according to an embodiment of the present disclosure.

### DETAILED DESCRIPTION OF THE EMBODIMENTS

The technical solutions in the embodiments of the present disclosure are clearly and completely described in following with reference to the accompanying drawings in the embodiments of the present disclosure, obviously, the described embodiments are part of the embodiments of the present disclosure, and not all of them. Based on the embodiments in the present disclosure, all other embodiments obtained by those skilled in the art without creative efforts are within the scope of the present disclosure.

The present solution provides a method for generating speech, for development of any intelligent dialogue system, it can quickly generate corresponding intention and speech according to the node (function node) in the intelligent dialogue system, and establish a relationship between intentions and skill service actions. The intelligent dialogue system can be any kind of voice interaction system that provides skill services, such as a bank customer service system, a communication carrier customer system, a video/audio playback system, a take-out ordering system, etc., it can be applied to a terminal device, such as an intelligent speaker, a mobile phone, a personal computer PC, etc., or applied to a server, or applied to an industrial control device, etc. Moreover, the method for generating speech of the present solution is applied to an apparatus for generating speech, and the apparatus for generating speech is included in an electronic device or a server.

Following describes the present solution through several specific embodiments.

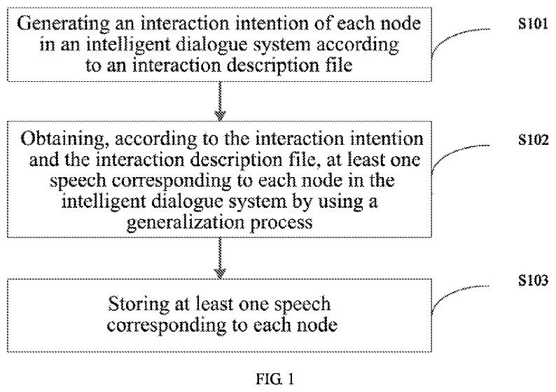

FIG. 1 is a schematic flowchart of Embodiment 1 of a method for generating speech according to an embodiment of the present disclosure, as shown in FIG. 1, the specific implementation steps of the method for generating speech include:

S101: generating an interaction intention of each node in an intelligent dialogue system according to an interaction description file.

It should be understood that the interaction description file includes node information of each node in the intelligent dialogue system, and the node information includes node names of each node and a relationship between the nodes, there are multiple levels of nodes in the intelligent dialogue system, therefore, the relationship between the nodes is used to indicate that each two nodes are a parent node and a child node, or two peer nodes. The nodes mentioned here may be understood as a kind of function nodes, each node corresponds to a skill service action, taking the intelligent dialogue system is a video/audio playback system as an example, if the node name is “music”, the skill service corresponding to the node is playing music, and if the node name is “movie”, the skill service corresponding to the node is playing a movie.

In this step, generate the interaction intention of each node in the intelligent dialogue system is obtained based on the interaction description file, such as an extensible markup language (XML) file. Specifically, the interaction intention of the node may be generated according to the node name of each node in the interaction description file, or the interaction intention of the node may be generated according to the node name of each node in the interaction description file and the node name of the parent node and/or the child node (i.e., a superior node and/or a subordinate node) of the node, or the interaction intention of the node may be generated according to the node name of each node in the interaction description file and the generated interaction intention of the parent node and/or the child node (i.e., the superior node and/or the subordinate node) of the node.

Still taking the intelligent dialogue system is a video/audio playback system as an example, if the node name is “music”, the interaction intention of the node is generated to listen to music, and if the node name is “movie”, the interaction intention of the node is generated to watch a movie, or if the node name is “Andy Lau” and the parent node name is “music”, the interaction intention of the node is generated to listen to Andy Lau's music, and if the node name is “Andy Lau” and the parent node name is “movie”, the generated interaction intention is to watch Andy Lau's movie.

S102: obtaining, according to the interaction intention and the interaction description file, at least one speech corresponding to each node in the intelligent dialogue system by using a generalization process.

For each node in the interaction description file, at least one speech corresponding to each node in the intelligent dialogue system is obtained according to the interaction intention of each node generated in step S101 by generalizing, generalization process refers to transformation of the same intention into different speech through multiple descriptions.

Here still taking the intelligent dialogue system is a video/audio playback system as an example, if the interaction intention is to watch a movie, then a variety of speech may be obtained through generalization process, such as “I want to watch a movie”, “Please play a movie” or “I want to watch a movie”, etc.

S103: storing at least one speech corresponding to each node.

In this step, storing at least one speech corresponding to each node in the intelligent dialogue system obtained in step S102, so that the intelligent dialogue system makes a call when performing a human-machine dialogue.

The method for generating speech provided by the embodiment, by generating an interaction intention of each node in an intelligent dialogue system according to an interaction description file, the interaction description file includes node information of each node in the intelligent dialogue system, obtaining, according to the interaction intention and the interaction description file, at least one speech corresponding to each node in the intelligent dialogue system by using a generalization process, and storing at least one speech corresponding to each node, high efficiency of generating speech is achieved by automatically generating the interaction intention of each node according to the description file, thereby generating at least one speech of each node, and the speech is enriched through the generalization process, avoiding the problem that the speech is insufficient in the prior art.

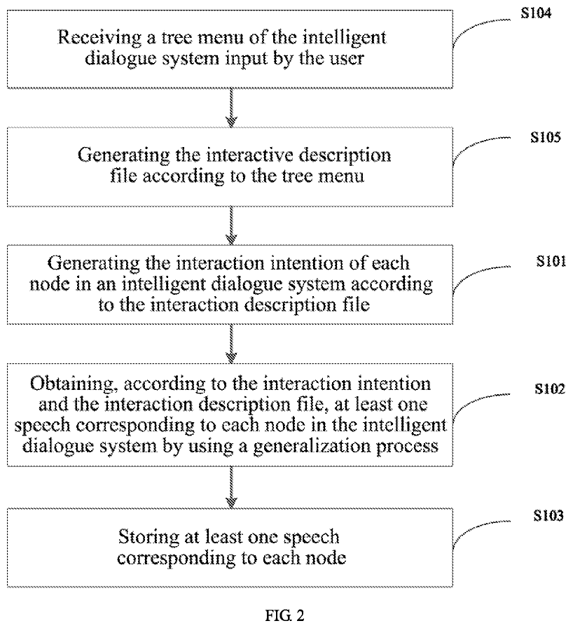

Based on the above embodiment, FIG. 2 is a schematic flowchart of Embodiment 2 of a method for generating speech according to an embodiment of the present disclosure, as shown in FIG. 2, before the step S101, the method for generating speech further includes following steps:

S104: receiving a tree menu of the intelligent dialogue system input by the user.

It should be understood that the tree menu is used to represent the relationship between each node in the intelligent dialogue system, and each node has a corresponding node name, the tree menu is a menu of a visual tree structure, and specifically may be a menu based on a Graphical User Interface (GUI).

In this step, receiving a tree menu of the intelligent dialogue system input by the user, specifically, the user may input through a visual editing module provided by this present solution.

S105: generating an interactive description file according to the tree menu.

Generating the interactive description file, such as an XML file, according to the tree menu. Specifically, this step includes converting nodes of each level in the tree menu of the intelligent dialogue system into node information of each node in the interaction description file.

In this embodiment, by receiving a tree menu of the intelligent dialogue system input by the user, and generating an interactive description file according to the tree menu, the intelligent dialogue system can be created by the user through visual editing without writing codes, thereby improving work efficiency.

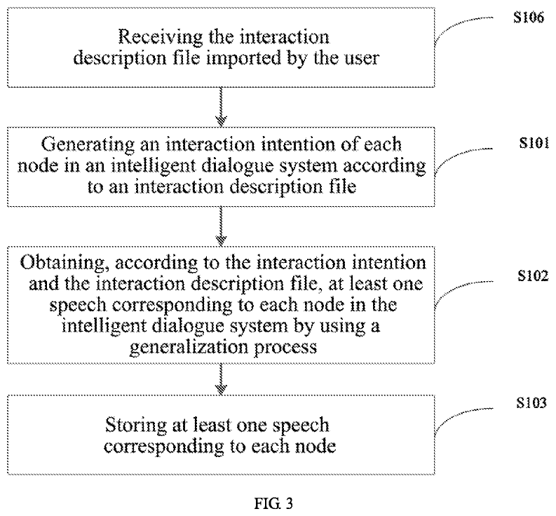

Based on the above embodiment, similar to the embodiment shown in FIG. 2, FIG. 3 is a schematic flowchart of Embodiment 3 of a method for generating speech according to an embodiment of the present disclosure, as shown in FIG. 3, before the step S101, the method for generating speech further includes:

S106: receiving the interaction description file imported by the user.

The method for obtaining the interaction description file may be implemented by step S106 in addition to step S104 and step S105 in the embodiment shown in FIG. 2, receiving the interaction description file imported by the user, the interaction description file may be an interaction description file generated by another device, or an interaction description file written by a user.

In this embodiment, by receiving the interaction description file directly imported by the user, the method for obtaining the interaction description file is more flexible, and thus the application of the present solution is more extensive.

The method for generating speech provided by the present solution, generating an interaction intention of each node in an intelligent dialogue system according to an interaction description file, includes: generating the interaction intention of the node according to each node and a superior node of the node and/or a subordinate node of the node. Specifically, if the node is a root node, that is, there is no superior node (also called a parent node), the interaction intention of the node is generated according to the node and the subordinate node of the node (also called a child node), if the node does not have the subordinate node, the interaction intention of the node is generated according to the node and the superior node of the node; if the node is not the root node and has the subordinate node, the interaction intention of the node is generated according to the node and the superior node and subordinate node of the node. Further, the generating the interaction intention of the node according to each node and the superior node of the node and/or a subordinate node of the node, may include generating the interaction intention of the node according to the node name of each node and the node name of the superior node of the node and/or subordinate node of the node, or, if the interaction intention has been obtained by the superior node of the node and/or subordinate node of the node, the interaction intention of the node is generated according to the node name of each node and the interaction intention of the superior node of the node and/or subordinate node of the node.

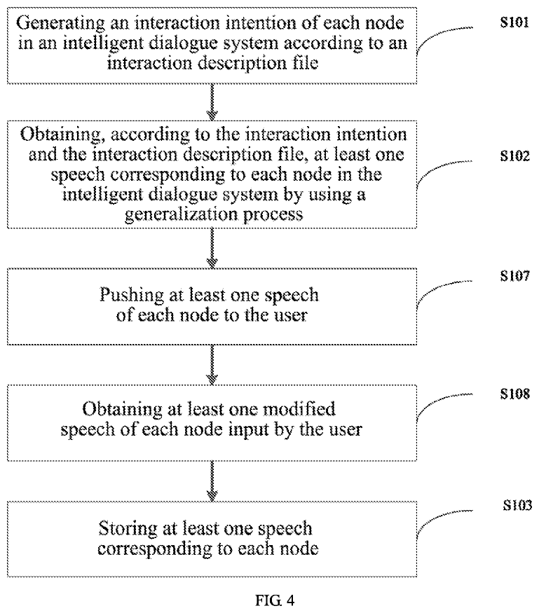

Based on the above embodiment, FIG. 4 is a schematic flowchart of Embodiment 4 of a method for generating speech according to an embodiment of the present disclosure, as shown in FIG. 4, before the S103, the method for generating speech further includes:

S107: pushing at least one speech of each node to the user.

In this step, after the step S102, at least one speech corresponding to each node in the intelligent dialogue system is obtained, then the at least one of the obtained speech is pushed to the user, which can be displayed to the user through a list, an image, a text, or the like.

S108: obtaining at least one modified speech of each node input by the user.

It should be understood that the user can edit any one or more speech to modify, add, or delete the one or more speech through a speech editing module provided by the present solution.

The steps in the embodiment shown in FIG. 2 or FIG. 3 may also be included in this embodiment.

In this embodiment, by pushing at least one obtained speech of each node to the user, so that the user modifies the speech to obtain at least one speech of each node that satisfies requirements, so as to perfect the final generated speech.

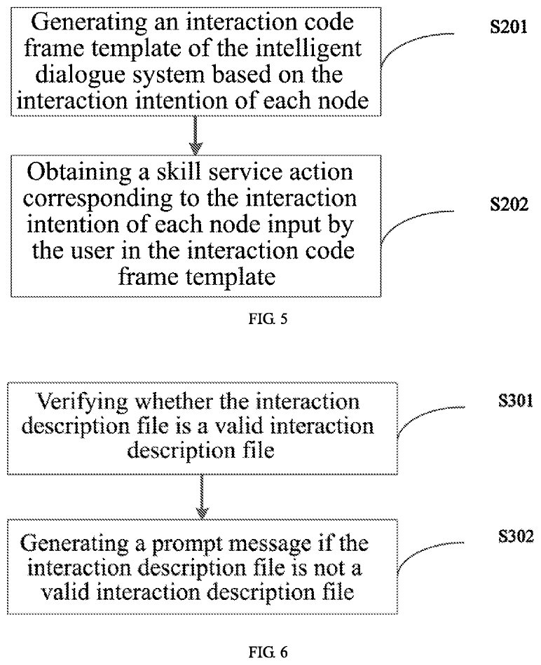

FIG. 5 is a schematic flowchart of Embodiment 5 of a method for generating speech according to an embodiment of the present disclosure, as shown in FIG. 5, the method for generating speech further includes:

S201: generating an interaction code frame template of the intelligent dialogue system based on the interaction intention of each node.

In this step, an code generating module provided by the present solution generates the interaction code frame template of the intelligent dialogue system based on the interaction intention of each node, the interaction code frame template can be generated for any particular computer programming language, such as Java, Javascript, PHP, Python, Go, etc. The interaction code frame template includes system intention and event of the intelligent dialogue system, and the system intention includes returning, jumping, opening, closing, etc., and the event is an action to be triggered corresponding to each interaction intention.

S202: obtaining a skill service action corresponding to the interaction intention of each node input by the user in the interaction code frame template.

The user inputs a corresponding skill service action for the interaction intention of each node based on the generated interaction code frame template of the intelligent dialogue system, for example, if the interaction intention of the node is to watch a movie, and the corresponding skill service action is to play a movie, the user writes logic code or migrates the existing code for the skill service action of playing the movie, Further, in this step, by obtaining the skill service action corresponding to the interaction intention of each node input by the user in the interaction code frame template, a connection between the interaction intention and the skill service action is completed.

In this embodiment, generating an interaction code frame template of the intelligent dialogue system based on the interaction intention of each node, and obtaining the skill service action corresponding to the interaction intention of each node input by the user in the interaction code frame template, the connection between the interaction intention and the skill service action is established on the basis of the interaction code frame template, compared with the developer needs to implement a large amount of code writing in the prior art, the present solution improves the development efficiency.

Based on the above embodiment, FIG. 6 is a schematic flowchart of Embodiment 6 of a method for generating speech according to an embodiment of the present disclosure, as shown in FIG. 6, the method for generating speech further includes:

S301: verifying whether the interaction description file is a valid interaction description file.

In order to ensure the accuracy and enforceability of the interaction intention of each node in the generated intelligent dialogue system, it is necessary to verify whether the interaction description file is a valid interaction description file.

In this step, verification of the validity of the interaction description file, including verifying whether there is a logical problem in the interaction description file, whether there are unrecognizable characters, and verifying normality and consistency of the interaction description file according to the description file specification.

S302: generating a prompt message if the interaction description file is not a valid interaction description file.

In this step, if the interaction description file is not a valid interaction description file after verification, a prompt message is generated, prompt the user to re-edit a tree menu or re-import the interaction description file until the valid interaction description file is obtained. Further, if the interaction description file is a valid interaction description file after verification, the interaction description file can be continued to use, for example, continue to generate the interaction intention of each node in the intelligent dialogue system according to the interaction description file.

The embodiment shown in FIG. 6 further includes steps in any of the above embodiments.

In this embodiment, by verifying that whether the interaction description file is a valid interaction description file, generating a prompt message if the interaction description file is not a valid interaction description file, where the prompt message is used to prompt the user to re-edit a tree menu or re-import the interaction description file, and implements verification on whether the interaction description file is valid, so as to ensure the accuracy and enforceability of the interaction intention of each node in the generated intelligent dialogue system.

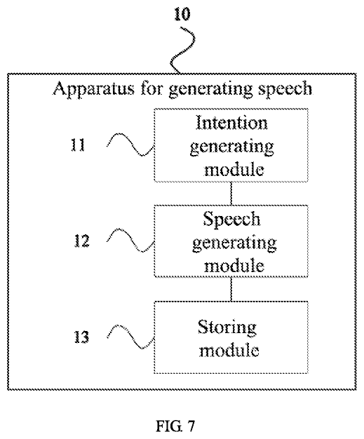

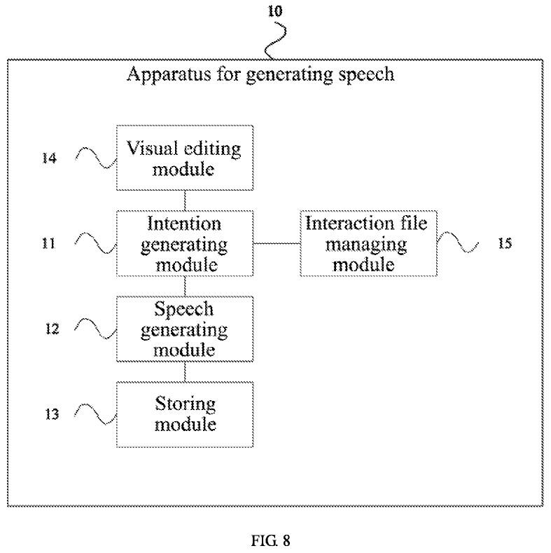

FIG. 7 is a schematic structural diagram of Embodiment 1 of an apparatus for generating speech according to an embodiment of the present disclosure, as shown in FIG. 7, the apparatus for generating speech 10 includes:

an intention generating module 11, configured to generate an interaction intention of each node in an intelligent dialogue system according to an interaction description file, where the interaction description file includes node information of each node in the intelligent dialogue system;

a speech generating module 12, configured to obtain, according to the interaction intention and the interaction description file, at least one speech corresponding to each node in the intelligent dialogue system by using a generalization process; and

a storing module 13, configured to store at least one speech corresponding to each node.

The apparatus for generating speech provided by this embodiment includes an intention generating module, a speech generating module and a storing module, by generating an interaction intention of each node in an intelligent dialogue system according to an interaction description file, where the interaction description file includes node information of each node in the intelligent dialogue system, obtaining, according to the interaction intention and the interaction description file, at least one speech corresponding to each node in the intelligent dialogue system by using a generalization process, and storing at least one speech corresponding to each node, high efficiency of generating speech is achieved by automatically generating the interaction intention of each node according to the description file, thereby generating at least one speech of each node, and the speech is enriched through the generalization process, avoiding the problem that the speech is insufficient in the prior art.

FIG. 8 is a schematic structural diagram of Embodiment 2 of an apparatus for generating speech according to an embodiment of the present disclosure, as shown in FIG. 8, the apparatus for generating speech 10 further includes:

a visual editing module 14, configured to receive a tree menu of the intelligent dialogue system input by a user, the tree menu is used to represent a relationship between each node;

the visual editing module 14 is further configured to generate the interaction description file according to the tree menu;

or,

an interaction file management module 15, configured to receive the interaction description file imported by the user.

The apparatus provided by this embodiment, may be used to perform the technical solution of the foregoing method embodiment, the implementation principle and technical effects are similar, and the details are not described herein.

In a specific implementation, the intention generating module is specifically configured to:

generate the interaction intention of the node according to each node and a superior node of the node and/or a subordinate node of the node.

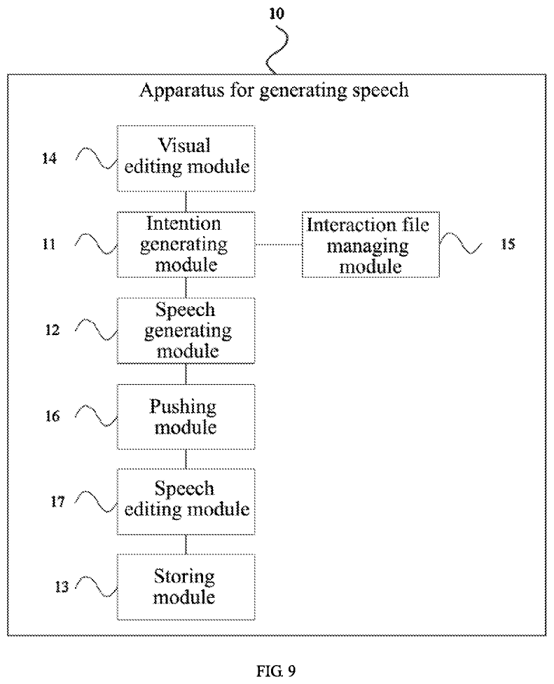

FIG. 9 is a schematic structural diagram of Embodiment 3 of an apparatus for generating speech according to an embodiment of the present disclosure, as shown in FIG. 9, the apparatus for generating speech 10 further includes:

a pushing module 16, configured to push at least one speech of each node to the user; and

a speech editing module 17, configured to obtain at least one modified speech of each node input by the user.

The apparatus provided by this embodiment, may be used to perform the present technical solution of the foregoing method embodiment, the implementation principle and technical effects are similar, and the details are not described herein.

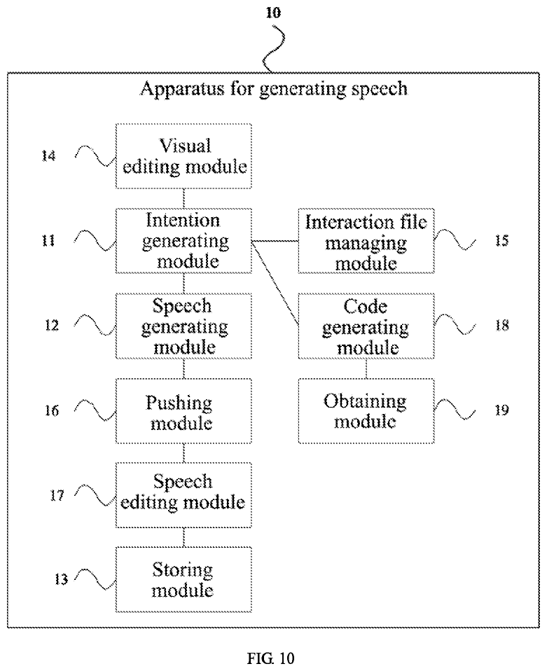

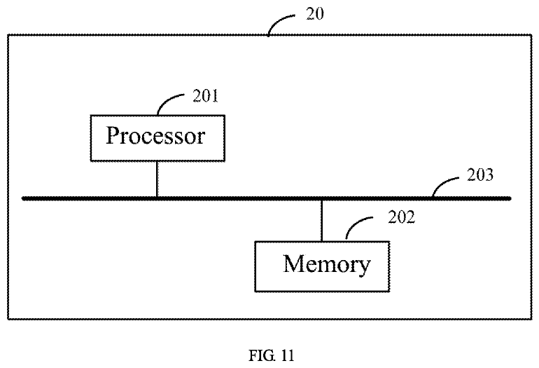

FIG. 10 is a schematic structural diagram of Embodiment 4 of an apparatus for generating speech according to an embodiment of the present disclosure, as shown in FIG. 10, the apparatus for generating speech 10 further includes:

a code generating module 18, configured to generate an interaction code frame template of the intelligent dialogue system according to the interaction intention of each node; and

an obtaining module 19, configured to obtain a skill service action corresponding to the interaction intention of each node input by the user in the interaction code frame template.

The apparatus provided by this embodiment, may be used to perform the technical solution of the foregoing method embodiment, the implementation principle and technical effects are similar, and the details are not described herein.

In a specific implementation, the interaction file management module is further configured to:

verify whether the interaction description file is a valid interaction description file; and

generate a prompt message if the interaction description file is not a valid interaction description file, where the prompt message is used to prompt the user to re-edit a tree menu or re-import the description file.

FIG. 11 is a schematic structural diagram of hardware of an electronic device according to an embodiment of the present disclosure. as shown in FIG. 11, the electronic device 20 of this embodiment includes: a processor 201 and a memory 202; where,

the memory 202, configured to store computer-executable instructions;

the processor 201, configured to execute a computer-executable instruction stored in the memory to implement the method for generating speech described in any of the foregoing embodiments. For details, refer to the related description in the foregoing method embodiment.

Optionally, the memory 202 may be independent or integrated with the processor 201.

When the memory 202 is independently set, the electronic device further includes a bus 203, configured to connect the memory 202 and the processor 201.

The embodiment of the present disclosure further provides a computer readable storage medium, where the computer readable storage medium is stored with computer-executable instructions which, when executed by a processor, implement the method for generating speech as described above.

In the several embodiments provided by the present disclosure, it should be understood that the disclosed device and method may be implemented in other manners. For example, the embodiments described above are merely illustrative, for example, the division of the module is only a logical function division, and the actual implementation may have another division manner, for example, multiple modules or components can be combined or can be integrated into another system, or some features can be ignored, or not executed. In addition, the mutual coupling or direct coupling or communication connection shown or discussed may be an indirect coupling or communication connection through some interfaces, apparatus or modules, and may be electrical, mechanical or otherwise.

The module described as a separate component may or may not be physically separated, the component displayed as a module may be or may not be a physical unit, that is, may be located in one place, or may be distributed to multiple network units. Part or all of the modules may be selected according to actual needs to achieve the purpose of the solution of the embodiment.

In addition, each functional module in each embodiment of the present disclosure may be integrated into one processing unit, or each module may exist physically separately, or two or more modules may be integrated into one unit. The unit formed by the above module can be implemented in a form of hardware or in a form of hardware plus software functional units.

The above integrated module implemented in the form of software function module can be stored in a computer readable storage medium. The software function module is stored in a storage medium, and includes a plurality of instructions for causing a computer device (which may be a personal computer, a server, or a network device, etc.) or a processor to perform some of steps of the methods described in various embodiments of the present application.

it should be understood that the processor may be a central processing unit (CPU), or may be other general-purpose processor, Digital Signal Processor (DSP), Application Specific Integrated Circuit (ASIC) etc. The general-purpose processor may be a microprocessor or any conventional processor, etc. The steps of the method disclosed in the embodiments of the present disclosure may be directly completed by a hardware processor, or completed by a combination of hardware and software modules in the processor.

The memory may include a high speed RAM memory, and may also include a nonvolatile storage NVM, such as at least one disk storage, and may also be a USB flash drive, a removable hard disk, a read only memory, a magnetic disk, or an optical disk.

The bus may be an Industry Standard Architecture (ISA) bus, a Peripheral Component (PCI) bus, or an Extended Industry Standard Architecture (EISA) bus, etc. The bus can be divided into an address bus, a data bus, a control bus, etc. For convenience of representation, the bus in the drawing of the present application does not limit only one bus or one type of bus.

The storage medium may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or optical disc. The storage medium can be any available medium that can be accessed by a general purpose or special purpose computer.

An exemplary storage medium is coupled to the processor, such that the processor can read information from the storage medium and can write information to the storage medium. Of course, the storage medium may also be an integral part of the processor. The processor and the storage medium may be located in an Application Specific Integrated Circuits (ASIC). Of course, the processor and the storage medium may also exist as discrete components in the device.

A person of ordinary skill in the art may understand that all or part of the steps of implementing the foregoing method embodiments may be completed by hardware related to the program instructions. The aforementioned program can be stored in a computer readable storage medium. The program, when executed, performs the steps including the foregoing method embodiments; and the foregoing storage medium includes: various media that can store program codes, such as a ROM, a RAM, a magnetic disk, or an optical disk.

Finally, it should be noted that the above embodiments are only used to explain the technical solutions of the present disclosure, and are not limited thereto; although the present disclosure has been described in detail with reference to the foregoing embodiments, those skilled in the art should understand that the technical solutions described in the foregoing embodiments may be modified, or some or all of the technical features may be equivalently replaced; however, these modifications or replacements do not detract from the essence of the technical solutions of the embodiments of the present disclosure.

What is claimed is:

1. A method for generating speech, comprising:
generating an interaction intention of each node in an intelligent dialogue system according to an interaction description file, wherein the interaction description file comprises node information of each node in the intelligent dialogue system;
obtaining, according to the interaction intention and the interaction description file, at least one speech corresponding to each node in the intelligent dialogue system by using a generalization process; and
storing at least one speech corresponding to each node.

2. The method according to claim 1, wherein before the generating an interaction intention of each node in an intelligent dialogue system according to an interaction description file, the method further comprises:
receiving a tree menu of the intelligent dialogue system input by a user, wherein the tree menu is used to represent a relationship between each node; generating the interaction description file according to the tree menu;
or,
receiving the interaction description file imported by the user.

3. The method according to claim 2, wherein the generating an interaction intention of each node in an intelligent dialogue system according to an interaction description file, comprises:
generating the interaction intention of the node according to each node and at least one of a superior node of the node and a subordinate node of the node.

4. The method according to claim 3, wherein before the storing at least one speech corresponding to each node, the method further comprises:
pushing at least one speech of each node to the user; and
obtaining at least one modified speech of each node input by the user.

5. The method according to claim 4, wherein the method further comprises:
generating an interaction code frame template of the intelligent dialogue system according to the interaction intention of each node; and
obtaining a skill service action corresponding to the interaction intention of each node input by the user in the interaction code frame template.

6. The method according to claim 1, wherein the method further comprises:
verifying whether the interaction description file is a valid interaction description file; and
generating a prompt message if the interaction description file is not a valid interaction description file, wherein the prompt message is used to prompt the user to re-edit a tree menu or re-import the interaction description file.

7. An apparatus for generating speech, comprising: a processor, a memory, and a computer program;
the memory stores computer-executable instructions;
the processor executes the computer-executable instructions stored in the memory, the processor executes the computer-executable instructions to:
generate an interaction intention of each node in an intelligent dialogue system according to an interaction description file, wherein the interaction description file comprises node information of each node in the intelligent dialogue system;
obtain, according to the interaction intention and the interaction description file, at least one speech corresponding to each node in the intelligent dialogue system by using a generalization process; and
store at least one speech corresponding to each node.

8. The apparatus according to claim 7, wherein the processor executes the computer-executable instructions further to:
receive a tree menu of the intelligent dialogue system input by a user, wherein the tree menu is used to represent a relationship between each node; generate the interaction description file according to the tree menu;
or,
the processor executes the computer-executable instructions further to receive the interaction description file imported by the user.

9. The apparatus according to claim 8, wherein the processor executes the computer-executable instructions further to:
generate the interaction intention of the node according to each node and a superior node of the node and/or a subordinate node of the node.

10. The apparatus according to claim 9, wherein the processor executes the computer-executable instructions further to:
push at least one speech of each node to the user; and
obtain at least one modified speech of each node input by the user.

11. The apparatus according to claim 10, wherein the processor executes the computer-executable instructions further to:
generate an interaction code frame template of the intelligent dialogue system according to the interaction intention of each node;
obtain a skill service action corresponding to the interaction intention of each node input by the user in the interaction code frame template.

12. The apparatus according to claim 7, wherein the processor executes the computer-executable instructions further to:
verify whether the interaction description file is a valid interaction description file;
generate a prompt message if the interaction description file is not a valid interaction description file, wherein the prompt message is used to prompt the user to re-edit a tree menu or re-import the description file.

13. A computer readable storage medium, wherein the computer readable storage medium is stored with computer-executable instructions which, when executed by a processor, implement steps of:
generating an interaction intention of each node in an intelligent dialogue system according to an interaction description file, wherein the interaction description file comprises node information of each node in the intelligent dialogue system;
obtaining, according to the interaction intention and the interaction description file, at least one speech corresponding to each node in the intelligent dialogue system by using a generalization process; and
storing at least one speech corresponding to each node.

14. The computer readable storage medium according to claim 13, wherein the computer readable storage medium is further stored with computer-executable instructions which, when executed by the processor, implement steps of:
receiving a tree menu of the intelligent dialogue system input by a user, wherein the tree menu is used to represent a relationship between each node; generating the interaction description file according to the tree menu;
or,
receiving the interaction description file imported by the user.

15. The computer readable storage medium according to claim 14, wherein the generating an interaction intention of each node in an intelligent dialogue system according to an interaction description file, comprises:
generating the interaction intention of the node according to each node and at least one of a superior node of the node and a subordinate node of the node.

16. The computer readable storage medium according to claim 15, wherein the computer readable storage medium is further stored with computer-executable instructions which, when executed by the processor, implement steps of:
pushing at least one speech of each node to the user; and
obtaining at least one modified speech of each node input by the user.

17. The computer readable storage medium according to claim 16, wherein the computer readable storage medium is further stored with computer-executable instructions which, when executed by the processor, implement steps of:
generating an interaction code frame template of the intelligent dialogue system according to the interaction intention of each node; and
obtaining a skill service action corresponding to the interaction intention of each node input by the user in the interaction code frame template.

18. The computer readable storage medium according to claim 13, wherein the computer readable storage medium is further stored with computer-executable instructions which, when executed by the processor, implement steps of:
verifying whether the interaction description file is a valid interaction description file; and
generating a prompt message if the interaction description file is not a valid interaction description file, wherein the prompt message is used to prompt the user to re-edit a tree menu or re-import the interaction description file.
